(19) United States
(12) Patent Application Publication
(10) Pub. No.: US 2002/0073289 A1
(43) Pub. Date: Jun. 13, 2002

(54) Method and system for backup copying

(76) Inventors: Harri Hyytiainen, Helsinki (FI); Llkka Kolho, Helsinki (FI)

Correspondence Address: Michael B. Lasky, Altera Law Group, 6500 City West Parkway - Suite 100, Minneapolis, MN, 55344-7701, US

(21) Appl. No.: 10/071,813

(22) Filed: Feb. 7, 2002

Related U.S. Application Data
(63) Continuation of application No. PCT/FI00/00722, filed on Aug. 24, 2000.

(30) Foreign Application Priority Data
Aug. 25, 1999 (FI) 19991811

(51) Int. Cl. G06F 12/00

(52) U.S. Cl. 711/162

(57) ABSTRACT

The invention relates to restoring a backup copy in a distributed telecommunication system comprising at least two computer units, each comprising means for generating a backup copy of the computer unit; a backup unit comprising means for storing a backup copy, and a communication system connecting the computer units to the backup unit. The backup copies of the computer units are saved to the backup unit and the backup copy is restored to the computer unit when necessary. Identification data identifying the computer unit is saved to the backup unit in conjunction with the backup copy. When a backup copy is to be restored, the backup copy is directed to a computer unit on the basis of the identification data. The invention makes it possible to automate the restoration of a backup copy of a distributed data system.

The present invention relates to telecommunication systems. In particular, the invention concerns a method and a system for restoring an integrated backup copy of a distributed data system to the data system.

### BACKGROUND OF THE INVENTION

Backup copying means copying data to another data medium to ensure an availability of the data. Backup copies are made in order to be prepared for a situation where access to the original data is lost.

Distributed data or computer systems, such as telephone systems, usually comprise a number of computers or processor-controlled devices specialized for given functions. In prior art, backup copying in a distributed system, especially a telephone exchange system, has been done by the operator by manually transferring a backup copy file from each computer unit to a single backup unit. Correspondingly, the backup copies have been restored manually to the computers one at a time. Therefore, restoring a backup copy is a difficult task and particularly susceptible to error functions.

Another solution for backup copying in a distributed system is to provide a separate backup unit in conjunction with each computer unit. In this case, however, the sharp increase in the costs and the complexity of the system become a problem.

The object of the present invention is to eliminate or at least to significantly alleviate the problems referred to above. A specific object of the invention is to disclose a new type of method and system for restoring a backup copy in a distributed data system, preferably a telephone exchange system.

### BRIEF DESCRIPTION OF THE INVENTION

The invention concerns a method for restoring a backup copy in a distributed telecommunication system. The telecommunication system comprises at least two computer units, which again comprise means for generating a backup copy of the computer unit. In addition, the system comprises a backup unit comprising means for storing a backup copy generated by a computer unit. The computer units are connected to the backup unit via a communication system. In the method, the backup copies of the computer units are stored in the backup unit and a backup copy is restored to the computer unit when necessary. According to the invention, identification data identifying the computer unit is saved along with the backup copy in the backup unit. When a backup copy is to be restored, the backup copy is directed to the appropriate computer unit on the basis of the identification data. In an embodiment, the backup copies are restored automatically to the correct computer units.

The identification data for the computer units can be defined by several parallel or alternative methods: defining the identification data in the name of the directory containing the backup copy, in the contents of the directory or in a separate file in the directory of the backup copy.

In the backup unit, the backup copy is preferably stored on a removable medium. Removable media include e.g. DAT DDS tape (DAT, Digital Audio Tape; DDS, Digital Data Storage), CD-RW, CD-R disk (CD-RW, Compact Disk-ReWritable; CD-R, CD-Recordable) or corresponding mass storage media based on optical storage or magneto-optical disks. The storage medium may also be a hard disk or a corresponding mass storage medium. In a preferred embodiment, the computer units and the backup unit belong to a telephone exchange system.

In addition, the invention concerns a system for restoring a backup copy in a telecommunication system as described above, comprising means for saving backup copies of computer units to a backup unit and means for restoring a backup copy to a computer unit when necessary. The system of the invention comprises means for saving identification data identifying the computer unit in conjunction with the backup copy to the backup unit and means for directing a backup copy to a given computer unit on the basis of the identification data.

In an embodiment, the system comprises means for automatically restoring backup copies to the appropriate computer units. For the definition of the identification data, the system may comprise means for defining identification data in the name of the directory of the backup copy, in the contents of the directory of the backup copy and/or in a separate file in the directory of the backup copy.

In a preferred embodiment, the backup unit comprises a removable medium, on which the backup copy is stored. The above-mentioned computer units and backup unit are preferably comprised in a telephone exchange system.

The present invention reduces the amount of work to be done by the operator in restoring a backup copy. Automatic restoration reduces the risk of occurrence of errors and allows the system to reach a normal operational condition sooner. The user is not required to concentrate on the restoration of a backup copy as in a situation where user has to restore the backup copies manually one at a time. Use of the invention is advantageous especially in a telephone exchange system, such as e.g. the DX200 switching system manufactured by Nokia. It is possible to take a backup copy of a distributed system free of discrepancies regarding transactions and to restore it again from the backup unit to the computer units of the distributed system.

### LIST OF ILLUSTRATIONS

In the following, the invention will be described in detail by the aid of a few examples of its embodiments with reference to the attached drawing, wherein

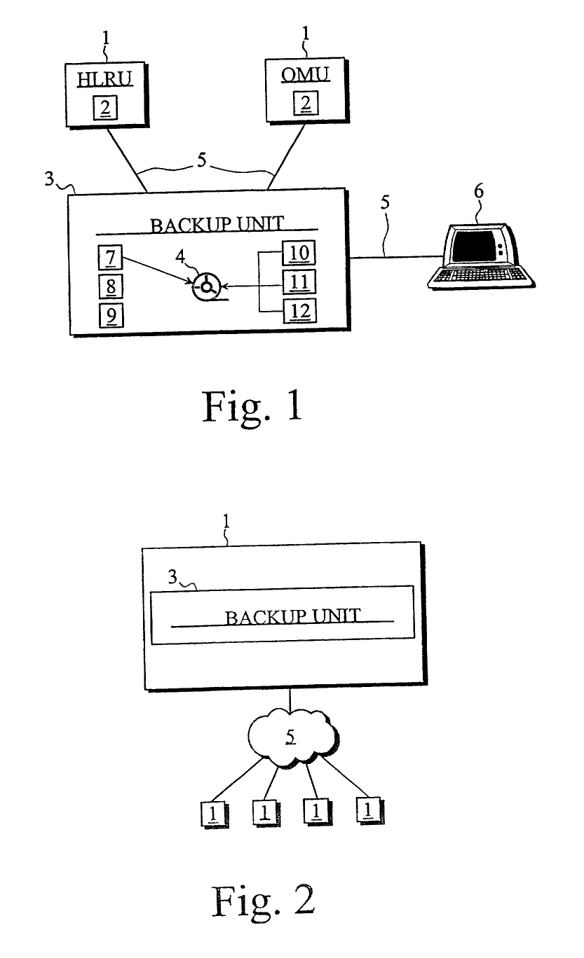

FIG. 1 presents a diagram representing a system according to the invention;

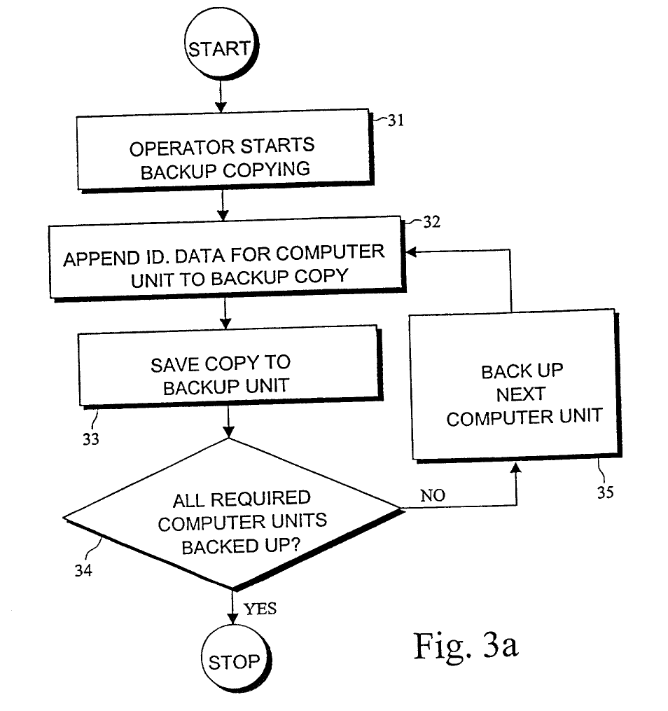

FIG. 2 presents a diagram representing another system in which the invention can be applied; and

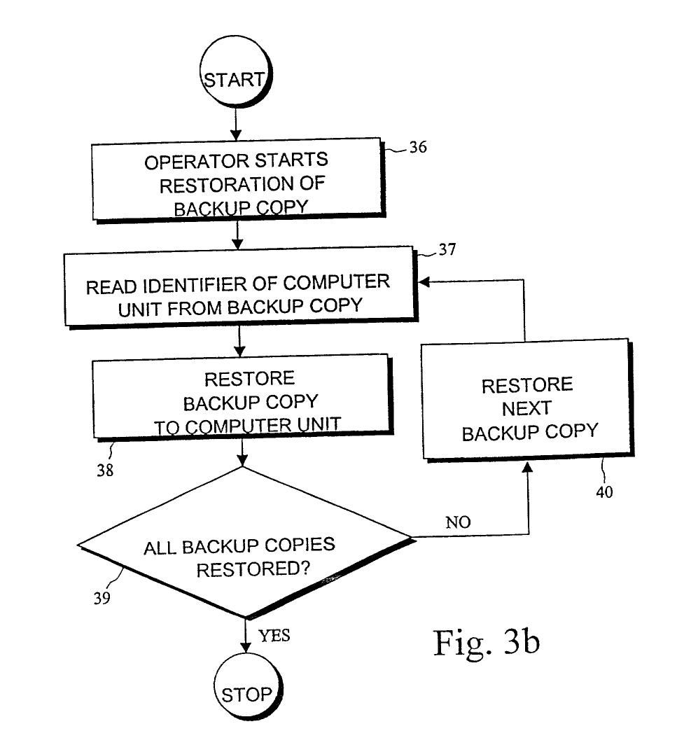

FIG. 3a and 3b present a flow diagram illustrating a method according to the invention.

### DETAILED DESCRIPTION OF THE INVENTION

FIG. 1 presents a simplified diagram of a system according to the invention. The diagram is presented by way of example and it does not include all the components of the particular system, these being known to the person skilled in the art. The above-mentioned distributed computer system is e.g. a telephone exchange system comprising a plurality of separate computer units 1. Of the components of the telephone exchange system, FIG. 1 presents computer units 1, i.e. a home location register unit HLRU and an operation and maintenance unit OMU. In addition, the figure shows a backup unit 3 and a terminal 6 that the operator can use to control the various steps of the backup copying operation. Except via the terminal 6, the backup copying can also be controlled from any point via a suitable MMI interface (Man Machine Interface, MMI) or API interface (API, Application Programming Interface). The components are interconnected via a communication system 5, which may be e.g. an internal message bus in the telephone exchange, a telephone network or a corresponding system applicable for the transmission of messages.

The backup unit 3 comprises means 4 for the storage of a backup copy. These means may consist of e.g. a DAT recorder or a corresponding tape recording device, a disk drive which can use e.g. a hard disk, CD-R or CD-RW disk or some other medium based on optical storage, a magneto-optic disk or other corresponding mass storage medium or removable medium. Moreover, means 4 comprise the software components, such as controllers, needed for the storage.

According to the invention, the system comprises means 7 for saving identification data identifying the computer unit to the storage media 4 of the backup unit in conjunction with the backup copy. The identification data is obtained e.g. from the data transmitted in the signalling of the communication system 5, or the computer unit 1 itself may append the identification data to the backup copy to be sent to the backup unit 3.

Using means 8, the backup copy is directed to the appropriate computer unit 1 on the basis of the identification data when the backup copy is being restored from the backup unit 3 to the computer unit 1. Using means 9, the restoration of the backup copies from the backup unit 3 to the computer units 1 is performed automatically. However, the stimulus for the restoration of the backup copies may come from the operator. The essential point is that the backup unit restores all or a predetermined set of the backup copies of the distributed system to the computer units 1 without the operator exerting any active control.

Using means 10, the above-mentioned identification data is defined in the name of the collected backup copy to be stored on the backup unit 3. Backup copies may be taken several times, so they can be distinguished from each other by the name. The directory name may be based on e.g. the time and/or the identification data for the computer unit. Correspondingly, using means 11, the identification data is defined in the contents of the directory of the backup copy, e.g. as a suitable filename within the directory. Further, using means 12, the identification data can be defined in a separate file in the directory of the backup copy. The above-mentioned solutions may also be used in various combinations so as to find the best solution as necessary in the situation in question.

The means 7-12 used in the system can be implemented e.g. via software, in which case it will be possible to make use of means already implemented in the system, such as microprocessors and storage mediums. The means 7-12 can also be implemented using discrete components, programmable circuits or an application-specific ASIC circuit (ASIC, Application Specific Integrated Circuit).

It is to be noted that the above description of the components of a distributed system can also be understood in a wider sense. FIG. 2 presents an example in which the backup unit 3 is comprised as a component in a computer unit 1, and the number of computer units 1 connected to the backup unit 3 may vary. For instance, the HLRU network element of the communication system contains several separate target units, each having a separate individual backup copy. In other words, the backup unit 3 may be comprised as a part in one 1 of the computer units, in which case the architecture of the backup unit 3 may be the architecture of the computer unit 1. At the same time, the backup unit 3 may be comprised in any computer unit 1 included in the centralized backup copying system. If the system contains more than one computer unit 1 comprising a backup unit 3, then backup copies can be taken and restored freely from different backup units.

In conjunction with the backup copy, it is also possible to store data indicating the system or network element used, allowing the concept of a distributed system to be broadened to cover e.g. a telephone network. In this case, it will be possible to restore a backup copy via an operation and maintenance link even from one network element to another, e.g. from an operation and maintenance center to a mobile switching center.

FIG. 3a and 3b present a flow diagram giving an example of the steps included in the method of the invention. In step 31, the operator starts backup copying. The operator uses e.g. a terminal 6 to give the start command. Each computer unit 1 generates a backup copy of its own memory, using means 2. The backup copy is transferred to the backup unit 3. At the same time, identification data identifying the computer unit 1 is appended to the backup copy, step 32. In step 33, the backup copy is stored on a removable medium 4 in the backup unit 3.

In step 34, a check is carried out to establish whether all the computer units 1 predetermined by the operator have already been backed up. If individual backup copies of all computer units 1 have already been saved to the backup unit 3, then the backup copying operation is terminated. If it is found that there are still computer units 1 not yet backed up, then the procedure will go on to step 35, where it prepares to back up the next computer unit 1, whereupon action is resumed at step 32.

Each one of the computer units 1 may perform its own internal backup copying at a suitable time, e.g. all computers at the same time. These backup copies form in the backup unit 3 a backup copy that is free of discrepancies regarding transactions, consisting of the several separate backup copies generated by the computer units 1.

In step 36, the operator starts the restoration of a backup copy, e.g. after the occurrence of a system crash or file corruption. The backup unit 3 checks the stored individual backup copies to establish the identification data of the target computer unit 1, step 37. The individual backup copy is restored to the computer unit, step 38. In step 39, the backup unit 3 checks whether all relevant backup copies have been restored to the computer units 1. If so, then the restoration operation is terminated, otherwise the procedure will go on to step 40, where it prepares to restore the next backup copy and returns to step 37. Thus, a backup copy free of discrepancies regarding transactions can be restored automatically to a distributed system.

The invention is not restricted to the example of its embodiments described above; instead, many variations are possible within the scope of the inventive idea defined in the claims.

1. Method for restoring a backup copy in a telecommunication system comprising:
at least two computer units (1), each comprising means (2) for generating a backup copy of the computer unit (1);
a backup unit (3) comprising means (4) for storing a backup copy; and
a communication system (5) connecting the computer units (1) to the backup unit (3); in which method:
the backup copies of the computer units (1) are saved to the backup unit (3); and
the backup copy is restored to the computer unit (1) when necessary, characterized in that
identification data identifying the computer unit (1) is saved to the backup unit (3) in conjunction with the backup copy; and
a backup copy is directed to a computer unit (1) on the basis of the identification data.

2. Method as defined in claim 1, characterized in that the backup copies are restored automatically to the appropriate computer units (1).

3. Method as defined in claim 1 or 2, characterized in that the identification data is defined in the name of the directory of the backup copy.

4. Method as defined in claim 1 or 2, characterized in that the identification data is defined in the contents of the directory of the backup copy.

5. Method as defined in claim 1 or 2, characterized in that the identification data is defined in a separate file in the directory of the backup copy.

6. Method as defined in any one of claims 1-5, characterized in that the backup copy is stored on a removable medium in the backup unit (3).

7. Method as defined in any one of claims 1-6, characterized in that the computer units (1) and the backup unit (3) belong to a telephone exchange system.

8. System for the restoration of a backup copy in a telecommunication system comprising:
at least two computer units (1), each comprising means (2) for generating a backup copy of the computer unit (1);
a backup unit (3) comprising means (4) for storing a backup copy;
a communication system (5) connecting the computer units (1) to the backup unit (3);
means (4) for storing the backup copies of the computer units (1) in the backup unit (3); and
means (6) for restoring the backup copy to the computer unit (1) when necessary, characterized in that the system comprises:
means (7) for saving identification data identifying the computer unit (1) to the backup unit (3) in conjunction with the backup copy; and
means (8) for directing a backup copy to a computer unit (1) on the basis of the identification data.

9. System as defined in claim 8, characterized in that the system comprises means (9) for automatic restoration of the backup copies to the appropriate computer units.

10. System as defined in claim 8 or 9, characterized in that the system comprises means (10) for defining the identification data in the name of the directory of the backup copy.

11. System as defined in claim 8 or 9, characterized in that the system comprises means (11) for defining the identification data in the contents of the directory of the backup copy.

12. System as defined in claim 8 or 9, characterized in that the system comprises means (12) for defining the identification data in a separate file in the directory of the backup copy.

13. System as defined in any one of claims 8-12, characterized in that the backup unit (3) comprises a removable medium (4), on which the backup copy is stored.

14. System as defined in any one of claims 8-13, characterized in that the computer units (1) and the backup unit (3) belong to a telephone exchange system.
